(19) United States
(12) Patent Application Publication
(10) Pub. No.: US 2024/0084086 A1
(43) Pub. Date: Mar. 14, 2024

(54) FOAMED ARTICLE AND METHOD FOR PREPARING THE SAME

(71) Applicant: Evonik Operations GmbH, Essen (DE)

(72) Inventors: Chenyu Ye, Shanghai (CN); Kathrin Salwiczek, Recklinghausen (DE); Dominik Vogel, Duesseldorf (DE); Beiyuan Zhu, Shanghai (CN); Michael Gerhard Hagemann, Shanghai (CN)

(73) Assignee: Evonik Operations GmbH, Essen (DE)

(21) Appl. No.: 18/261,787

(22) PCT Filed: Dec. 23, 2021
(86) PCT No.: PCT/CN2021/140725

§ 371 Date: Jul. 17, 2023

(30) Foreign Application Priority Data
Jan. 18, 2021 (WO) PCT/CN2021/072498

(51) Int. Cl. C08J 9/00; C08G 69/40; C08J 9/12; C08L 23/08; C08L 71/02; C08L 77/06

(52) U.S. Cl. CPC C08J 9/0061; C08G 69/40; C08J 9/122; C08L 23/0853; C08L 23/0869; C08L 71/02; C08L 77/06; C08G 2101/00; C08J 2201/03; C08J 2203/06; C08J 2203/08; C08J 2205/06; C08J 2323/08; C08J 2331/04; C08J 2371/02; C08J 2377/06; C08L 2203/14; C08L 2205/03; C08L 2207/04

(57) ABSTRACT

A polymeric blend contains a polyether block amide and a thermoplastic polymer, where the polyether block amide is based on a subunit 1 and a subunit 2. Subunit 1 is composed of at least one linear aliphatic diamine containing 5 to 15 carbon atoms and at least one linear aliphatic dicarboxylic acid containing 6 to 16 carbon atoms. Subunit 2 is composed of at least one polyether diol containing at least 3 carbon atoms per ether oxygen and primary OH groups at the chain ends. The sum total of the carbon atoms from diamine and dicarboxylic acid is an odd number and is 19 or 21 carbon atoms. The number-average molar mass of the subunit 2 is 200 to 900 g/mol. The thermoplastic polymer is selected from an ethylene/vinylene acetate, a thermoplastic polyester elastomer, a polyolefin elastomer, thermoplastic polyurethane, or any mixture thereof.

### FIELD OF THE PRESENT DISCLOSURE

The present disclosure relates to a foamed article and to a method for preparing the same.

### BACKGROUND

Flexible polymeric foams were widely applied in sport shoe sole assembly to decrease weight and provide sufficient flexibility. Traditionally, the plastic flexible foams were generated via chemical reaction by chemical blowing agents, which are usually hazard substances and/or cause unfriendly odors. Recent years, usage of supercritical state gas as blowing agents has been introduced into sport shoe sole manufacture. In that technology, supercritical state gas, e.g., N₂, CO₂, acts as physical blowing agent. Furthermore, foamed thermoplastics have been prepared by some advanced supercritical state gas foaming technologies where cross-linkers are not necessary, which makes production not only more environment friendly but also more economic since the thermoplastic foam can be recycled.

Such technology has been applied on various thermoplastic elastomers, e.g., polyether block amide (PEBA), thermoplastic polyurethane (TPU), ethylene-vinyl acetate (EVA), polyolefin elastomers, to make flexible foams for shoe soles. There is a continuing demand for low weight polymeric foams especially in sports industry. As the density of polymeric foams decreases, mechanical strengths and modulus also deteriorate, making low density foams unsuitable for applications requiring considerable strengths such as resilience and stiffness.

### SUMMARY OF THE PRESENT DISCLOSURE

It is one objective of the present disclosure to provide a polymeric blend made from homogenously mixed polymeric blend, which can maintain desired performances including adjustable mechanical hardness, low density, and good resilience.

Such objective is achieved by providing a polymeric blend comprising a polyether block amide and a thermoplastic polymer, wherein the polyether block amide is based on a subunit 1, composed of at least one linear aliphatic diamine containing 5 to 15 carbon atoms and at least one linear aliphatic dicarboxylic acid containing 6 to 16 carbon atoms, and on a subunit 2, composed of at least one polyether diol containing at least 3 carbon atoms per ether oxygen and primary OH groups at the chain ends, wherein the sum total of the carbon atoms from diamine and dicarboxylic acid is an odd number and is 19 or 21 carbon atoms; the number-average molar mass of the subunit 2 is 200 to 900 g/mol, and the thermoplastic polymer is selected from an ethylene/vinylene acetate, a thermoplastic polyester elastomer, a polyolefin elastomer, a thermoplastic polyurethane, or any mixture thereof.

Preferably, the number-average molar mass of the subunit 2 is 400 to 700 g/mol.

Preferably, the polyether diol is selected from polypropane-1,3-diol, poly(tetramethylene ether) glycol, or mixtures thereof.

Preferably, the number-average molar mass of the subunit 1 is 250 to 4,500 g/mol.

More preferably, the number-average molar mass of the subunit 1 is 400 to 2,500 g/mol.

Preferably, the number of carbon atoms in the linear aliphatic diamine is an even number and the number of carbon atoms in the linear aliphatic dicarboxylic acid is an odd number.

Preferably, the sum total of the carbon atoms from the linear aliphatic diamine and the linear aliphatic dicarboxylic acid is 19.

Preferably, the subunit 1 is selected from nylon-6,13, nylon-10,9, and nylon-12,9.

Preferably, the linear aliphatic diamine has 6 to 12 carbon atoms.

Preferably, the linear aliphatic dicarboxylic acid has 6 to 14 carbon atoms.

Preferably, the polyether block amide has a weight percentage of 10% to 90%, preferably a weight percentage of 15% to 80%, more preferably a weight percentage of 20% to 50%, based on a total weight of the polymeric blend.

Preferably, the polymeric blend further comprises a compatibilizer including a copolymer with at least one of ethylene, an acrylic ester, maleic anhydride, or glycidyl (meth)acrylate as a comonomer.

More preferably, the compatibilizer has a weight percentage of 1% to 10% based on a total weight of the polymeric blend.

Another perspective of the present disclosure is to provide a polymeric foam prepared from the polymeric blend.

Preferably, the polymeric foam has a density of less than 0.2 g/cm 3, more preferably less than 0.15 g/cm 3, still more preferably less than 0.1 g/cm 3.

Another perspective of the present disclosure is to provide an article produced from the polymeric foam.

Another perspective of the present disclosure is to provide a method for preparing a polymeric foam, comprising: providing a polymer and a polyether block amide, compounding the polymer and the polyether block amide and forming a blend, foaming the blend and obtaining a polymeric foam, wherein the polyether block amide is based on a subunit 1, composed of at least one linear aliphatic diamine containing 5 to 15 carbon atoms and at least one linear aliphatic dicarboxylic acid containing 6 to 16 carbon atoms, and on a subunit 2, composed of at least one polyether diol containing at least 3 carbon atoms per ether oxygen and primary OH groups at the chain ends, wherein the sum total of the carbon atoms from diamine and dicarboxylic acid is an odd number and is 19 or 21 carbon atoms; the number-average molar mass of the subunit 2 is 200 to 900 g/mol, and the thermoplastic polymer is selected from an ethylene/vinylene acetate, a thermoplastic polyester elastomer, a polyolefin elastomer, a thermoplastic polyurethane, or any mixture thereof. Thermoplastic polymer selected from Ethylene/vinylene acetate, a thermoplastic polyester elastomer, a thermoplastic polyurethane, or any mixture thereof is preferred.

Hereinafter, the term “compounding” means mixing of components in a molten state to form a homogenous blend.

According to some embodiments, the step of compounding the polyether block amide and the thermoplastic polymer is conducted by using a single-screw compounder or a twin-screw extruder, preferably a twin-screw extruder.

According to some embodiments, the step of foaming the blend comprises soaking the preform in a supercritical gas.

According to some embodiments, the supercritical gas is one or more selected from supercritical nitrogen, supercritical carbon dioxide, and a mixture thereof.

According to some embodiments, the step of foaming the blend is under a temperature lower than a melting temperature of the blend.

According to some embodiments, the supercritical gas is under a temperature of 20° C. to 300° C., preferably 60° C. to 250° C., more preferably 80° C. to 200° C.

According to some embodiments, the supercritical gas is under a pressure of 20 bar to 500 bar, preferably 60 bar to 400 bar, more preferably 100 bar to 400 bar.

According to some embodiments, the step of foaming the blend is carried out in an autoclave.

### BRIEF DESCRIPTION OF THE DRAWINGS

FIGS. 1 through 3 show a photograph of two hydrolyzed three-stage plates prepared from polymeric blends of a PEBA and an EVA with a weight percentage of the PEBA being 30 wt. %, 50 wt. %, and 70 wt. %, respectively.

FIGS. 4, 5, and 13 show a photograph of two hydrolyzed three-stage plates prepared from polymeric blends of a PEBA, an EVA, and 5 wt. % of a compatibilizer with a weight percentage of the PEBA being 45 wt. %, 65 wt. %, and 20 wt. %, respectively.

FIGS. 6 through 8 show a photograph of two hydrolyzed three-stage plates prepared from polymeric blends of a PEBA and a TPEE with a weight percentage of the PEBA being 30 wt. %, 50 wt. %, and 70 wt. %, respectively.

FIGS. 9 through 11 show a photograph of two hydrolyzed three-stage plates prepared from polymeric blends of a PEBA and a TPEE with a weight percentage of the PEBA being 30 wt. %, 50 wt. %, and 70 wt. %, respectively.

FIG. 12 shows a photograph of two hydrolyzed three-stage plates prepared from polymeric blends of a PEBA and a TPU with a weight percentage of the PEBA being 30 wt. %, 50 wt. %, and 70 wt. %, respectively.

### DETAILED DESCRIPTION

Polyether block amides (PEBA) are block copolymers which are obtained by polycondensation of (oligo)polyamides, in particular acid-regulated polyamides, with alcohol-terminated or amino-terminated polyethers. Acid-regulated polyamides have carboxylic acid end groups in excess. Those skilled in the art refer to the polyamide blocks as hard blocks and the polyether blocks as soft blocks. The production thereof is known in principle. DE2712987A1 (U.S. Pat. No. 4,207,410) describes polyamide elastomers of this type, composed of lactams containing 10-12 carbon atoms, dicarboxylic acids, and polyether diols. The products obtainable according to this document are distinguished by long-lasting flexibility and ductility even at low temperatures, but they are already cloudy to opaque in moldings of moderate layer thickness and, on longer-term storage at room temperature, are conspicuous due to surface deposits having a mildew-like appearance. Similarly, structured polyamide elastomers, assembled from diamines containing 6-20 carbon atoms, aliphatic or aromatic dicarboxylic acids and polyether diols, are known from EP0095893. Distinctive properties are increased heat distortion resistance and flexibility. No data regarding translucency of the moldings and formation of deposits can be gathered from this document.

[Subunit 1]

Subunit 1 is composed of at least one linear aliphatic diamine containing 5 to 15 carbon atoms, preferably 6 to 12 carbon atoms, and at least one linear aliphatic dicarboxylic acid containing 6 to 16 carbon atoms, preferably 6 to 14 carbon atoms.

In one preferred embodiment, the number-average molar mass of the subunit 1 is 250 to 4,500 g/mol, more preferably 400 to 2,500 g/mol, even more preferably 400 to 2,000 g/mol, most preferably 500 to 1,600 g/mol.

Preferably, the sum total of the carbon atoms from diamine and dicarboxylic acid in the PEBA is 19.

It is preferable for the number of carbon atoms in the diamine to be an even number and for the number of carbon atoms in the acid to be an odd number.

Suitable polyamides of subunit 1 are selected, by way of example, from 5,14, 5,16, 6,13, 6,15, 7,12, 7,14, 8,11, 8,13, 9,10, 9,12, 10,9, 10,11, 11,8, 11,10, 12,7, 12,9, 13,6, 13,8. It is furthermore preferable for the subunit 1 to be selected from nylon-6,13, nylon-10,9 and nylon-12,9.

[Subunit 2]

Subunit 2 refers to a polyether linkage in the PEBA. The number-average molar mass of the subunit 2 is 200 to 900 g/mol. When preparing the PEBA, often one or more polyether diol or polyether diamine is used as a starting material. Polyether diol forming the PEBA could be any polyether with at least 3 carbon atoms per ether oxygen and primary OH groups at the chain ends.

Preferably, the number-average molar mass of the subunit 2 is 400 to 700 g/mol.

More preferably, the polyether diol of the PEBA is selected from polypropane-1,3-diol, polytetramethylene glycol, and mixtures thereof.

[Compounding and Foaming]

Polyether block amide and thermoplastic polymer are compounded to form a blend. The thermoplastic polymer is selected from an ethylene/vinylene acetate, a thermoplastic polyester elastomer, a polyolefin elastomer, a thermoplastic polyurethane, or any mixture thereof. The compounding method can involve a mixer with a strong shear. Preferred mixers include a twin-screw extruder.

After compounding, the polymeric blend is subject to shaping and then a preform is formed. The preform can be formed by any shaping method or process. Preferred are processes including compression-molding, extrusion molding, coextrusion molding, blow molding, 3D blow molding, coextrusion blow molding, coextrusion 3D blow molding, coextrusion suction blow molding, injection molding, stereolithography, digital light processing, continuous liquid interface production, fused filament fabrication, sheet lamination, selective laser melting, etc. More preferred are extrusion molding and injection molding.

The preform undergoes a foaming process and a foamed article is obtained.

Preferably, the step of foaming the blend comprises soaking the preform in a supercritical gas. Known supercritical gas includes supercritical nitrogen, supercritical carbon dioxide, or mixture thereof.

Foaming the preform can be preferably conducted under a temperature lower than a melting temperature of the blend to keep the blend from melting or softening, thereby maintaining the shape of preform. In some embodiments, foaming is under a temperature of 20 to 300° C., preferably 60° C. to 250 more preferably 80° C. to 200° C..

The foaming process is conducted in a pressurized atmosphere. Foaming is under a pressure of 20 bar to 500 bar, preferably 60 bar to 400 bar, more preferably 100 bar to 400 bar.

According to some embodiments, an autoclave is used to carried out the foaming process. The term “autoclave” refers to any device that is capable to carry out heating under an elevated pressure in relation to ambient pressure. In that sense, the autoclave may include a conventional autoclave, a high-pressure reactor, a foaming mold, etc.

[Foams and Foamed Article]

The compounded polymeric blend can undergo a foaming process, in which a foaming agent, preferably a physical foaming agent, blows up the composition. In the end of the foaming process, a foamed article is formed. The foamed article can have a plurality of microcells distributed inside, which make the density of the foamed article very low, compared to that of the un-foamed composition. The foamed article also can express a multitude of mechanical properties that are desired in various applications, such as, a high compression set, a good ball rebound resilience, a high hardness Asker C value, etc. The compression set can be lower than 40%. The ball rebound resilience can be larger than 60%. The foamed article can have a hardness Asker C value of about 30 to 70 or preferably about 35 to 55.

The polymeric foam has a density of less than 0.2 g/cm 3, preferably less than 0.15 g/cm 3, more preferably less than 0.1 g/cm 3.

The foamed article can find many applications in the form of articles of clothing, footwear, protective equipment, straps, and components thereof. In addition, the foamed article can be used in the form of automotive insulation, automotive seating, automotive interior, thermal and acoustic insulation. In some embodiments, the foamed article can be a shoe sole.

[Compatibilizer]

To fascinate homogeneous mixing of PEBA and the thermoplastic polymer, a compatibilizer is preferably added before initiation of mechanical mixing. The compatibilizer may include a copolymer prepared from copolymerization of one or more comonomers selected from ethylene, a (meth)acrylic ester, maleic anhydride, or glycidyl (meth)acrylate. More preferably, the compatibilizer is an ethylene-acrylic ester-maleic anhydride terpolymer, an ethylene-acrylic ester-glycidyl acrylate terpolymer, an ethylene-acrylic ester-glycidyl methacrylate terpolymer, or any mixture thereof.

The compatibilizer may be purchased commercially from various suppliers, such as Arkema S. A. and SK Global Chemical Co., Ltd. under the trademarks of Lotader® series and Bondine® series.

Based on the total weight of the polymeric blend, the compatibilizer preferably has a weight percentage of 1% to 10%, more preferably weight percentage of 2% to 8%, still more preferably weight percentage of 3% to 5% within the polymeric blend.

The present disclosure is illustrated by way of example and comparative example hereinbelow.

Materials and Testing

The following materials were employed in the examples:

Vestamid® e²X 41 is a polyether block amide elastomer from Evonik Operations GmbH; it contains polyamide 6.13, i.e. the sum total of the carbon atoms from diamine and dicarboxylic acid is 19 carbon atoms.

TAISOX® 7350M from Formosa Plastics Corporation is an ethylene/vinylene acetate copolymer, containing about 18 wt. % of vinyl acetate. It has a Shore A hardness of 88 and a Shore D hardness of 38.

Hytrel® 4056 and Hytrel® G4078LS from DuPont are low modulus thermoplastic polyester elastomers.

Lotader® 3410 from Arkema S. A. is a compatibilizer comprising random terpolymer of ethylene, acrylic ester, and maleic anhydride, polymerized by high-pressure autoclave process.

Elastollan® 1180A from BASF Polyurethanes GmbH is a thermoplastic polyurethane based on methylene diphenyl diisocyanate, poly(tetrahydrofuran) with number average molecular weight (Mn) of about 1,000 g/mol, poly(tetrahydrofuran) with average Mn of about 2,000 g/mol, and butanediol. It has a Shore A hardness of 80.

Tensile modulus of elasticity, tensile stress at yield, and tensile stress at break were determined by Zwick Z020 materials testing system according to ISO 527, on ISO tensile specimens, type 1A, 170 mm×10 mm×4 mm at a temperature (23±2) ° C., relative humidity (50±10) %.

Notched impact strength was determined by CEAST Resil Impactor 6967.000, according to ISO 179/1eA (Charpy) on tensile specimens ISO 527 type 1A which were cut off two ends, 80 mm×10 mm×4 mm at a temperature (23±2) ° C., relative humidity (50±10) %.

Vicat temperatures was determined by a CEAST 500 AlOxide HDT/Vicat instrument according to ISO 306.

Hardness (shore D) was determined by Time Group Shore D hardness tester TH210, according to ISO 868, on tensile specimens ISO 527 type 1A 170 mm×10 mm×4 mm at a temperature (23±2) ° C., relative humidity (50±10) %.

Hardness (Asker C) of foamed articles was determined by Asker Durometer Type C, according to JIS K 7312.

In accordance with ASTM D 3574, foam samples were placed in and compressed by a compression device to be deflected to 50% of its original thickness. The foam samples were then allowed to relax for 22 hours at 50° C. The original and final thicknesses were measured with a caliper. Compression set was calculated by dividing the difference in thickness with the original thickness.

Ball rebound resilience was determined with a ball rebound resilience tester by vertically dropping a steel ball on foam from a given height and measuring the rebound height in accordance with ASTM D 3574.

Injection-moulded plaques measuring 1-2-3 three-stage plates were produced from the polymeric blend as test specimens. The three-stage plate has a width of 55 mm. Each stage has a length of 30 mm. For the first, second, and third stages, the thickness is 1 mm, 2 mm, and 3 mm, respectively.

The CIE L*, a*, b* color (D65/10) and opacity (Y) were determined using a ColorFlex® Spectrocolorimeter (commercially available from Hunter Associates Laboratory, Reston, Va.) with 5 mm ring and white ceramic and black glass disks. “L*” represents lightness (100-0), “a*” redness (+) or greenness (—), and “b*” yellowness (+) or blueness (—) of the sample on the CIE L*, a*, b* scale. This scale is based on the principles described in ASTM E 308 Standard Practice for Computing the Colors of Objects by Using the CIE System. The Whiteness index is calculated by deriving the formula: =(L*/b*)−a*>7.5 implies the sample looks white based on physical observation.

Blooming was ascertained after the three-stage plates had been stored for a test period of 7 days in a closed vessel with water vapor with a 95% humidity at 70° C. Blooming level was assessed visually using a four-point scale (from Ito IV, where I=free of blooming, and IV=subject to heavy blooming).

### EXAMPLES

Vestamid® e²X and one thermoplastic elastomer were mixed using a Coperion ZSK-26 cm co-rotating twin screw extruder, discharged, pelletized to obtain compounded PEBA blend. The temperature was set to 220° C. and a screw rotation speed was set to 250 rounds per minute (RPM). The compounding was conducted with a throughput of 20 kg/h. Specific energy input was 0.154-0.163 kWh/kg. Torque was 57-62%. The weights of Vestamid® e²X and the thermoplastic elastomers and the trade name of thermoplastic elastomers are given in Tables 1 and 2.

The compounded PEBA blend compositions in pellet form were processed on an injection molding machine Engel VC 650/200 (melt temperature 220° C., mold temperature 35° C.) to prepare shoe sole preforms for further foaming. Injection pressure and holding pressure were 400 bar and 600 bar, respectively.

The shoe sole preforms was dispositioned in the autoclave to contacted with supercritical CO₂ at a pressure of 300 bar under a temperature of 140° C. for 1 hour. Then the pressure was reduced to ambient pressure while the temperature was maintained. The autoclave was then allowed to cool down. The foamed article was obtained after the autoclave cooled to room temperature.

The compatibility and color test results of compounded PEBA blend pellets are shown in Tables 1 and 2. Mechanical test results for foam prepared from Example 6 are given in Table 3.

TABLE 1
Test results of compounded PEBA-EVA pellets

| | 1 | 2 | 3 | 4 | 5 | 6 |
|---|---|---|---|---|---|---|
| Vestamid e²X 41 | 30 | 50 | 45 | 70 | 65 | 20 |
| (wt %) | | | | | | |
| Taisox 7350 (wt %) | 70 | 50 | 50 | 30 | 30 | 75 |
| Lotader 3410 (wt %) | | | 5 | | 5 | 5 |
| Compatibility | Good | Good | Good | Good | Good | Good |
| Color L | 90 | 91.04 | 90.13 | 91.66 | 91.02 | 82.52 |
| Color a | 0.08 | −0.25 | −0.12 | −0.34 | −0.24 | 0.02 |
| Color b | 5.91 | 5.86 | 5.77 | 5.94 | 5.67 | 6.65 |
| Haze | 57.35 | 73.94 | 78.41 | 80.88 | 84.56 | 81.25 |
| Blooming level | 1 | 1 | 1 | 1 | 1 | 2 |

TABLE 2
Test results of compounded PEBA blends

| | 7 | 8 | 9 | 10 | 11 | 12 | 13 |
|---|---|---|---|---|---|---|---|
| Vestamid e²X 41 | 30 | 50 | 70 | 30 | 50 | 70 | 85 |
| (wt. %) | | | | | | | |
| Hytrel 4056 (wt. %) | 70 | 50 | 30 | | | | |
| Hytrel 4078LS (wt. %) | | | | 70 | 50 | 30 | |
| Elastollan | | | | | | | 15 |
| 1180 (wt. %) | | | | | | | |
| Compatibility | Good | Good | Good | Good | Good | Good | Good |
| Color L | 59.35 | 62.91 | 68.34 | 70.44 | 73.03 | 77.12 | 93.64 |
| Color a | 0.68 | 0.15 | −0.42 | −0.08 | −0.25 | −0.28 | −2.08 |
| Color b | 19.76 | 19.13 | 17.8 | 16.99 | 14.32 | 12.37 | 10.26 |
| Haze | 99.15 | 99.17 | 99.1 | 98.28 | 97.26 | 94.38 | 5.82 |
| Blooming level | 1 | 1 | 2 | 1 | 2 | 2 | 3 |

TABLE 3
Test results of foam prepared from Example 6

| Property | Test method | Value | |
|---|---|---|---|
| Hardness | JIS K-7312 | Asker C 40 | |
| Density | ISO 845 | 0.11 | kg/m³ |
| Ball Resilience | ISO 8307 | 63% | |
| Tensile Elongation | ISO 1798 | >300% | |
| Tensile strength | ISO 1798 | 1.3 | MPa |

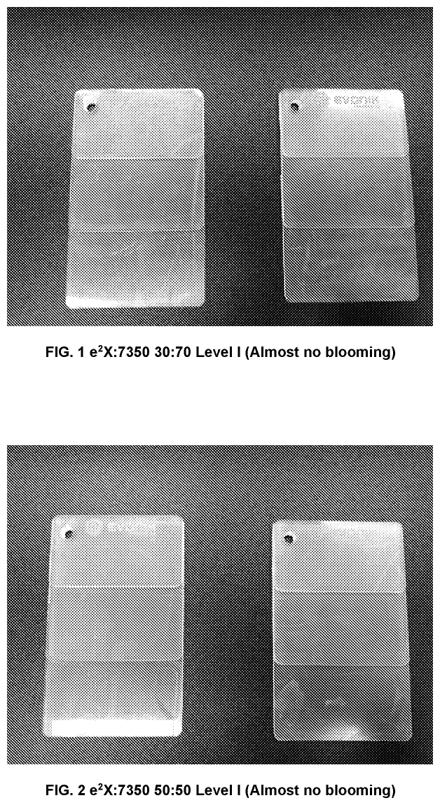

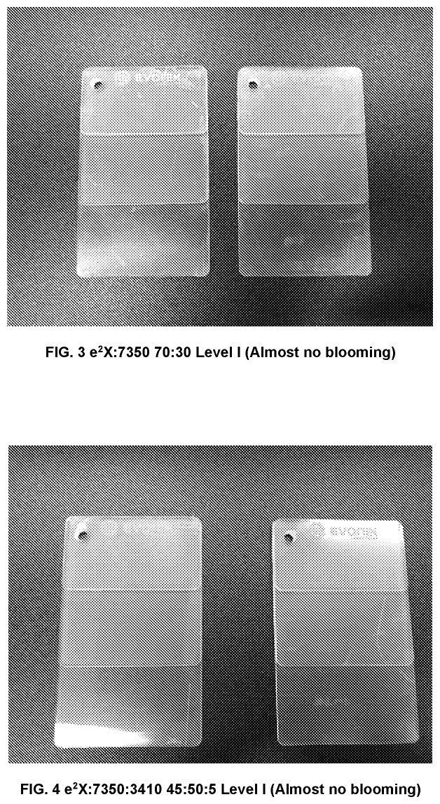

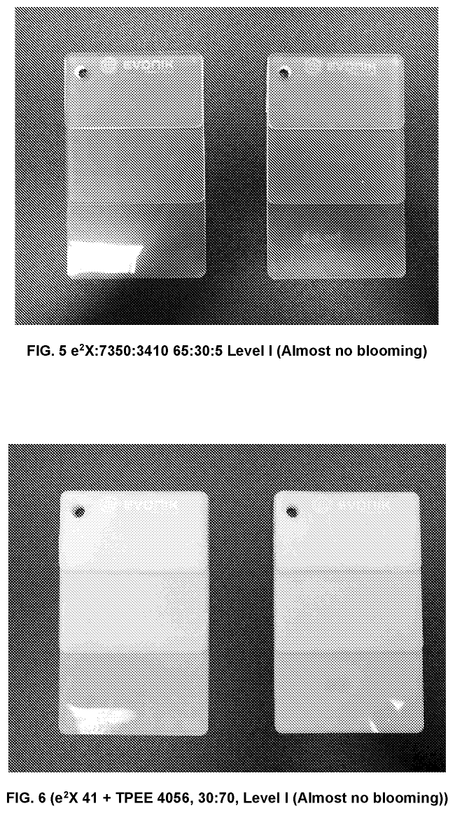

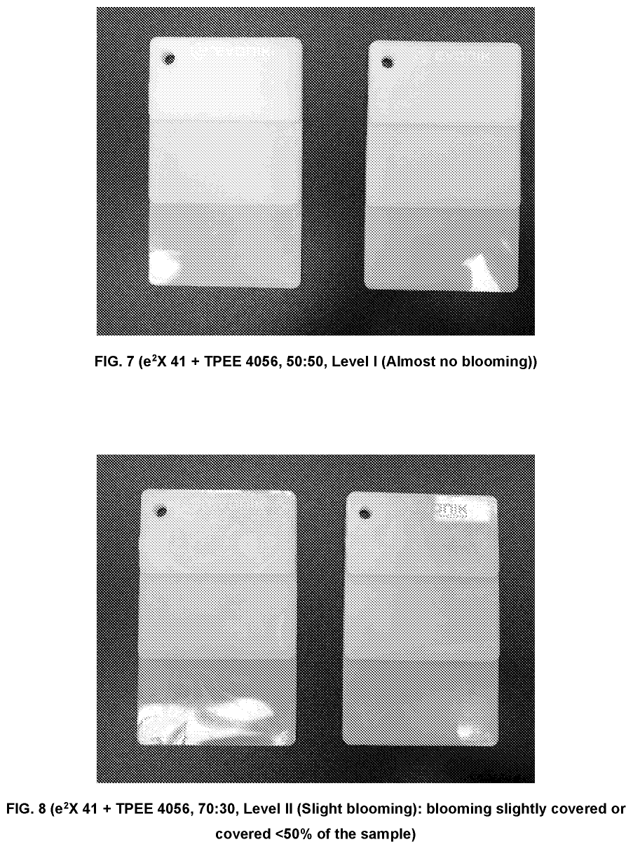

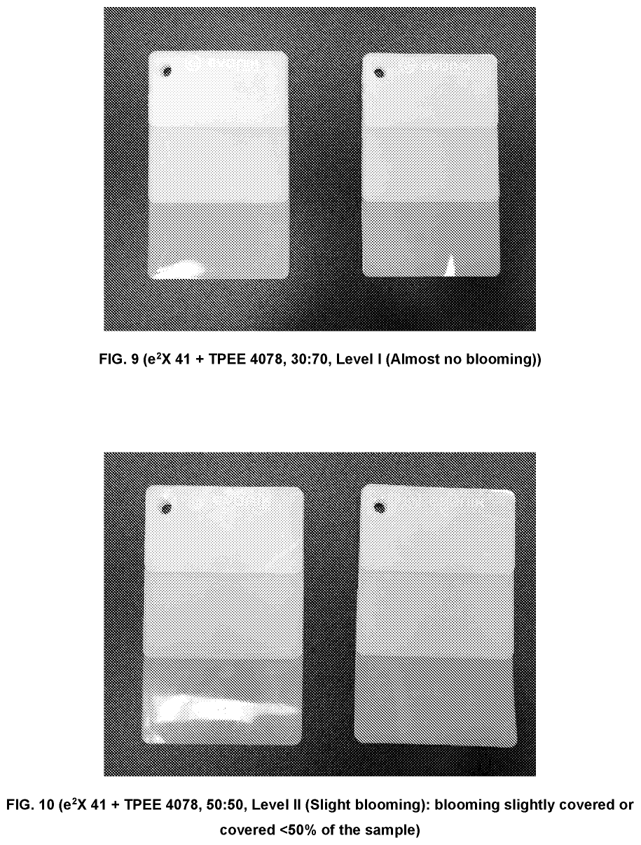

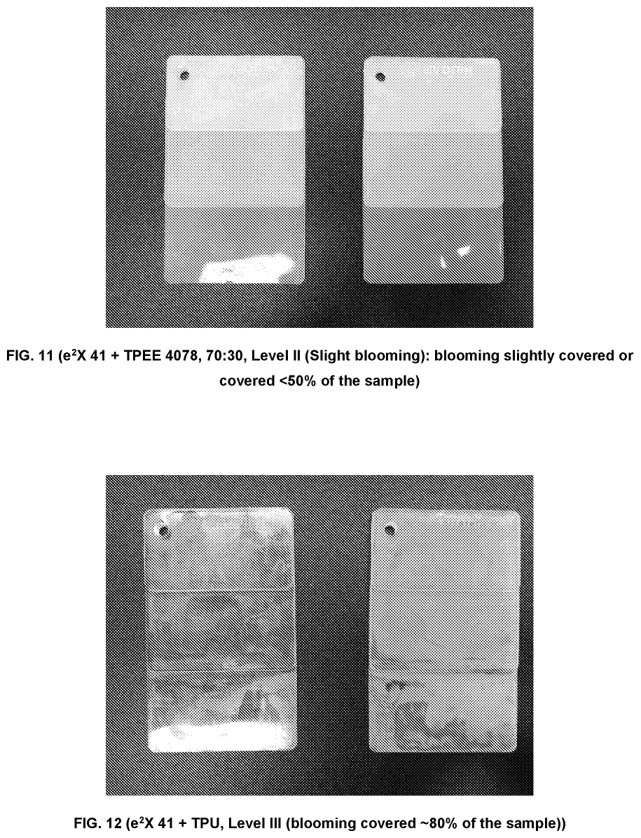

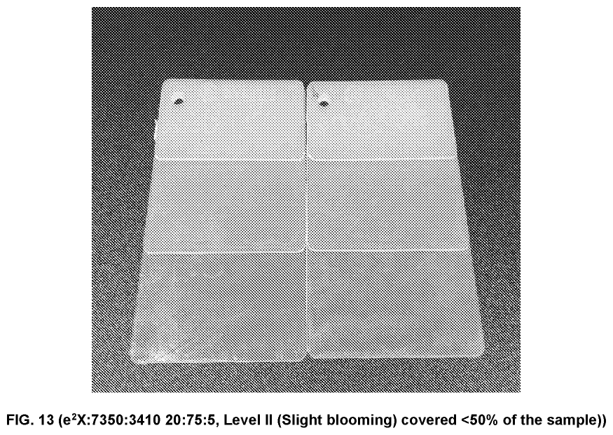

The plates prepared from the polymeric blends showed high transparency with no or little blooming even after a 7-day long hydrolysis under elevated temperature, as indicated in FIGS. 1 through 13. Without bound by any theory, the homogeneous mixing of PEBA and other thermoplastic polymers may contribute to the feature. The hydrolysis resistance also makes the polymeric blend suitable for various application in all-weather environment, such as, sports, automotive, navigation, etc. Compared with FIG. 9, FIG. 10 and FIG. 11 showed increased blooming level with weight percentages of PEBA within the polymeric blend increased from 30% to 50% and 70%, respectively.

From the test results of foam, it is shown that the foam has a very low bulk density and remains resilient and tough.

Various aspects and embodiments are possible. Some of those aspects and embodiments are described herein. After reading this specification, skilled artisans will appreciate that those aspects and embodiments are only illustrative and do not limit the scope of the present disclosure.

1: A polymeric blend, comprising:
a polyether block amide, and
a thermoplastic polymer,
wherein the polyether block amide is based on
a subunit 1, composed of at least one linear aliphatic diamine containing 5 to carbon atoms and at least one linear aliphatic dicarboxylic acid containing 6 to 16 carbon atoms, and
a subunit 2, composed of at least one polyether diol containing at least 3 carbon atoms per ether oxygen and primary OH groups at the chain ends,
wherein a sum total of the carbon atoms from diamine and dicarboxylic acid is an odd number and is 19 or 21 carbon atoms;
wherein a number-average molar mass of the subunit 2 is 200 to 900 g/mol, and
wherein the thermoplastic polymer is selected from the group consisting of an ethylene/vinylene acetate, a thermoplastic polyester elastomer, a polyolefin elastomer, a thermoplastic polyurethane, and any mixture thereof.

2: The polymeric blend according to claim 1, wherein the number-average molar mass of the subunit 2 is 400 to 700 g/mol.

3: The polymeric blend according to claim 1, wherein the at least one polyether diol is selected from the group consisting of polypropane-1,3-diol, poly(tetramethylene ether) glycol, and mixtures thereof.

4: The polymeric blend according to claim 1, wherein a number-average molar mass of the subunit 1 is 250 to 4,500 g/mol.

5: The polymeric blend according to claim 3, wherein a number-average molar mass of the subunit 1 is 400 to 2,500 g/mol.

6: The polymeric blend according to claim 1, wherein the number of carbon atoms in the at least one linear aliphatic diamine is an even number and the number of carbon atoms in the at least one linear aliphatic dicarboxylic acid is an odd number.

7: The polymeric blend according to claim 1, wherein the sum total of the carbon atoms from the at least one linear aliphatic diamine and the at least one linear aliphatic dicarboxylic acid is 19.

8: The polymeric blend according to claim 1, wherein the subunit 1 is selected from the group consisting of nylon-6,13, nylon-10,9, and nylon-12,9.

9: The polymeric blend according to claim 1, wherein the at least one linear aliphatic diamine has 6 to 12 carbon atoms.

10: The polymeric blend according to claim 1, wherein the at least one linear aliphatic dicarboxylic acid has 6 to 14 carbon atoms.

11: The polymeric blend according to claim 1, wherein the polyether block amide has a weight percentage of 10% to 90%, based on a total weight of the polymeric blend.

12: The polymeric blend according to claim 1, further comprising a compatibilizer including a copolymer with at least one of ethylene, an acrylic ester, maleic anhydride, or glycidyl (meth)acrylate as a comonomer.

13: The polymeric blend according to claim 12, wherein the compatibilizer has a weight percentage of 1% to 10% based on a total weight of the polymeric blend.

14: A polymeric foam, prepared from the polymeric blend according to claim 1.

15: The polymeric foam according to claim 14, wherein the polymeric foam has a density of less than 0.2 g/cm³.

16: An article, produced from the polymeric foam according to claim 14.

17: A method for preparing a polymeric foam according to claim 14, the method comprising:
providing a polymer and a polyether block amide,
compounding the polymer and the polyether block amide and forming a blend, and
foaming the blend and obtaining a polymeric foam,
wherein the polyether block amide is based on
a subunit 1, composed of at least one linear aliphatic diamine containing 5 to carbon atoms and at least one linear aliphatic dicarboxylic acid containing 6 to 16 carbon atoms, and
a subunit 2, composed of at least one polyether diol containing at least 3 carbon atoms per ether oxygen and primary OH groups at the chain ends,
wherein the sum total of the carbon atoms from diamine and dicarboxylic acid is an odd number and is 19 or 21 carbon atoms;
wherein the number-average molar mass of the subunit 2 is 200 to 900 g/mol, and
wherein the thermoplastic polymer is selected from the group consisting of an ethylene/vinylene acetate, a thermoplastic polyester elastomer, a polyolefin elastomer, a thermoplastic polyurethane, and any mixture thereof.

18: The polymeric blend according to claim 11, wherein the polyether block amide has a weight percentage of 20% to 50%, based on the total weight of the polymeric blend.

19: The polymeric foam according to claim 15, wherein the polymeric foam has a density of less than 0.1 g/cm³.
